(19) United States
(12) Patent Application Publication
(10) Pub. No.: US 2026/0054561 A1
(43) Pub. Date: Feb. 26, 2026

(54) HYBRID ELECTRIC POWERTRAIN FOR TRACKED VEHICLES

(71) Applicant: Clemson University, Clemson, SC (US)

(72) Inventors: Qilun Zhu, Greenville, SC (US); Atharva Ghate, Clemson, SC (US); Robert Prucka, Greenville, SC (US)

(73) Assignee: Clemson University, Clemson, SC (US)

(21) Appl. No.: 19/304,819

(22) Filed: Aug. 20, 2025

Related U.S. Application Data
(60) Provisional application No. 63/685,316, filed on Aug. 21, 2024.

(51) Int. Cl. B60K 6/442; B60K 6/365; B60L 7/10; B62D 11/04; B62D 55/06

(52) U.S. Cl. CPC B60K 6/442; B60K 6/365; B60L 7/10; B62D 11/04; B62D 55/06; B60T 2270/60; B60Y 2200/25; B60Y 2200/92

(57) ABSTRACT

The present invention relates to a hybrid electric powertrain for tracked vehicles that includes an electric motor that is operatively connected to a first ring gear in a first planetary gear set that drives the track; a combustible engine that is operatively connected to an axle that drives a first sun gear in the first planetary assembly; a clutch that engages and disengages a first output drive shaft powered by the engine to a second output shaft that rotates the axle; and a brake assembly that prevents the axle from causing the sun gear to rotate when the first ring gear is being rotated by the electric motor, thereby allowing the vehicle to operate in a fully electric mode. In one embodiment the brake assembly may include an axle clutch that disengages the first sun gear from the axle.

### RELATED APPLICATIONS

This application claims priority from U.S. Provisional Patent Application 65/785,316 filed Aug. 21, 2024 and incorporated by reference.

### GOVERNMENT LICENSE RIGHTS

This invention was made with government support under W56HZV-21-2-0001 awarded by the United States Army. The government has certain rights in the invention.

### BACKGROUND OF THE INVENTION

### 1) Field of the Invention

The present disclosure relates to hybrid electric powertrains for vehicles, and more particularly to a power split hybrid electric powertrain system for tracked vehicles that integrates electric motors with planetary gear assemblies to enable operation using an internal combustion engine alone, electric motors alone, or in combination.

### 2) Description of the Related Art

Drawbacks exist for both series and parallel hybrid tracked vehicle configurations. In series configurations, the electric motor is directly connected to the driven wheels (such as the left and right sprockets for a tracked vehicle). Instead of directly powering the drivetrain, the gas engine serves as a generator that powers the electric motor and, in combination with regenerative braking, recharges the battery. In such a configuration, the power created by the engine is transmitted first through a generator and then to the motors, which in turn power the drivetrain and rotate the wheels. Because the mechanical energy created by the engine must first be converted to electrical energy and then converted back to mechanical energy, there are efficiency losses resulting from the conversions taking place as compared to the use of mechanical transmission components.

Another disadvantage of series hybrid configurations is that the motors and generators are oversized. The traction motors need to provide full power and torque for extreme operating conditions, and the generator needs to absorb all engine power when needed. The oversized components are heavy, less efficient in common low load operation, and expensive. A drive system with more efficient, appropriately sized motors and engines is needed for improved range and efficiency.

In a parallel hybrid, the engine and motor work together to power the drivetrain. A computer splits the power demands between the two systems as needed to optimize efficiency. Because the engine is connected directly to the transmission, parallel hybrids do not have to convert the engine's mechanical energy into electrical energy and then back into mechanical energy through the motor, the way a series hybrid does. However, the mechanical link between the engine and the sprocket means the engine does not have complete freedom to select any desired optimal operating point. While it is possible to optimize driveline design to improve efficiency for more steady state highway driving, parallel hybrid configurations have low efficiency and high emissions for common tracked vehicle operations, such as frequent stop-start and turning, due to vastly varying engine speed and torque output.

To address some of these drawbacks, manufacturers such as Toyota invented the “power split” hybrid technology, including that which applies to Toyota's Prius vehicles, making them one of the most successful hybrid vehicles on the market. The power split uses a series-parallel combination hybrid system that allows the vehicle to operate entirely on either the gas engine or the generator/battery system, independently. At low speeds, the electric motor powers the drive train and rotates the wheels. At middle speeds, the power split utilizes a series mode where the engine is used to charge the generator, and the electric motor powers the drive train. At high speeds, the power split uses an engine-only or parallel mode where both the engine and the electric motor power the drive train. To achieve this, a power split hybrid design uses a planetary gear set to efficiently distribute power between an internal combustion engine, an electric motor, and the wheels.

Traditionally, hybrid tracked vehicles are based on series or parallel designs rather than the hybrid power split technology deployed in tracked vehicles as in the present invention. Traditionally, the use of 2 or 3 electric motors have been used in combination with a gas engine to power the drive train in parallel or series. In these prior art arrangements, components such as a steering motor and a transmission are typically used. The disadvantage of this arrangement is that the motor must actively be used to initiate steering of the tracked vehicle.

Disadvantages of current system can be illustrated when traditional tracked vehicle turns. In this case, the emissions increase which can include a plumb of dark smoke. This visual disturbance can show the location of the tracked vehicle, which is a disadvantage on the battlefield. The reduction of emissions is an advantage that is needed. Traditionally, when a tracked vehicle turns, more torque is put on one sprocket than the other which can cause an engine to have higher fuel to air ration thereby producing a plumb of black smoke. There is a need for a system that allows the electric motors to control steering so that the disadvantages of prior art are not present. Further, with the use of electric motors, energy needs are reduced.

It would be advantageous for a true power split system for tracked vehicles to be provided that can eliminate the need for a steering motor such that the power split system could steer the vehicle without the need to include steering components like a steering motor and/or transmission.

It would be advantageous if such a system could incorporate smaller batteries that require fewer cooling requirements.

### BRIEF SUMMARY OF THE INVENTION

The above objectives are accomplished by providing a hybrid electric powertrain for tracked vehicles comprising a left track and a right track; a left planetary gear assembly and a right planetary gear assembly, each planetary gear assembly including a sun gear, planetary gears, and a ring gear; electric motors operatively connected to reduction gears that engage with the ring gears of the planetary gear assemblies; a battery providing electrical power to the electric motors; carrier shafts extending from each planetary gear assembly and connecting to drive sprockets that engage with and drive the left track and right track; an internal combustion engine providing mechanical power through a first output gear shaft that connects to a second output gear shaft, which connects to a third output gear shaft through a reverse gear; an axle housing supporting an axle, which is further supported by an axle support; a central motor positioned to provide additional power input to the system; an outside brake assembly and a ring brake assembly providing control over component rotation; and an axle brake that may be engaged to prevent rotation of the axle.

In one embodiment, the invention further comprises a second planetary gear assembly wherein the second sun gear of the second assembly is carried by the first carrier shaft of the first assembly such that when the first carrier shaft is rotated, the second sun gear is also rotated. The electric motors are operatively connected to the ring gears through the reduction gears, and when the axle brake is engaged to prevent rotation of the axle, the electric motors provide power solely through the ring gears to drive the left track and right track.

In another embodiment, the brake assembly is engaged to prevent rotation of the axle, thus disengaging the first output gear shaft from the second output gear shaft. The central motor is operatively connected to provide additional power input through the third output gear shaft, and the reverse gear allows for forward and reverse operation of mechanical power transmission from the internal combustion engine.

In at least one embodiment, an output shaft clutch interconnecting the first output gear shaft to the second output gear shaft is placed in an open position when the brake assembly is engaged. The system is configured to operate in multiple modes including an engine-only mode, an electric-only mode, and a hybrid mode where both the internal combustion engine and electric motors provide power simultaneously.

In one embodiment, the brake assembly includes an axle clutch interconnecting the axle to the first sun gear wherein when the brake assembly is engaged, the axle clutch is placed in an open position thus preventing the axle from rotating the first sun gear. The first motor, second motor, and third motor may be independently controlled to provide differential power distribution, allowing the first track and second track to operate at different speeds for vehicle steering.

In at least one embodiment, the first ring gear of the first planetary gear assembly has an unlocked position where the first sun gear may rotate freely and a locked position where the first sun gear may not rotate and wherein the first ring gear is placed in a locked position when the first sun gear is rotated by the axle. The planetary gear assemblies are power-splitting assemblies adapted to allow power from both the internal combustion engine and electric motors to be combined and distributed to the left track and right track.

In at least one embodiment, the first carrier shaft of the first planetary gear assembly has an unlocked position where the first carrier shaft may rotate freely and a locked position where the first carrier shaft may not rotate so that when the first carrier shaft is placed in a locked position, rotation of the sun gear will cause the first ring gear to rotate thus rotating the electric motor and recharging the battery. The carrier shafts output the combined power from the planetary gear assemblies to the drive sprockets, which transfer rotational force to move the left track and right track.

The present invention integrates electric motors with the planetary gear assemblies in a cross-drive system that splits power from the engine to left and right tracks. With added brakes and clutches, this design also allows full electric operation without the engine. The system is configured to provide steering capability through differential speed control of the left track and right track by independently controlling the electric motors and brakes, eliminating the need for dedicated steering motors or complex transmission systems typically required in conventional tracked vehicle designs.

### BRIEF DESCRIPTION OF THE SEVERAL VIEWS OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1A illustrates a schematic of a hybrid electric powertrain system for tracked vehicles, according to aspects of the present disclosure.

FIG. 1B illustrates a schematic of the hybrid electric powertrain system of FIG. 1A, according to an embodiment.

FIG. 1C illustrates a schematic of the hybrid electric powertrain system of FIG. 1A with a transverse engine orientation, according to an embodiment.

FIG. 2 illustrates a schematic of the hybrid electric powertrain system of FIG. 1A, according to an embodiment.

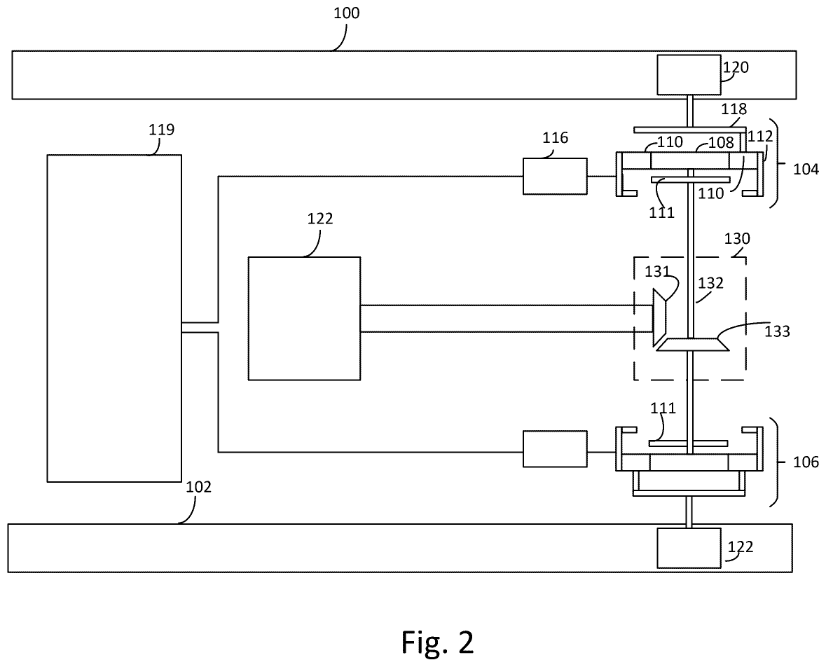

FIG. 3 illustrates a flowchart of a method for optimizing a hybrid design, according to aspects of the present disclosure.

FIGS. 4-5 depict a graph showing combined motor and controller efficiency characteristics, according to an embodiment.

FIGS. 6, 7A, 7B depict a chart showing vehicle requirements for a tracked vehicle, according to aspects of the present disclosure.

FIGS. 8A-8B depict a graph showing torque requirements for each track of a tracked vehicle, according to an embodiment.

FIGS. 9A-9B depict a graph showing maximum power required for an outer track of a tracked vehicle, according to an embodiment.

FIG. 10 illustrates a schematic view of a planetary gear assembly, according to aspects of the present disclosure.

FIG. 11 illustrates a schematic of the hybrid electric powertrain system of FIG. 1A, according to an embodiment.

FIG. 12 illustrates a schematic of the hybrid electric powertrain system of FIG. 1A with brake assemblies, according to an embodiment.

FIG. 13 illustrates a schematic of the hybrid electric powertrain system of FIG. 1A, according to an embodiment.

FIG. 14 illustrates a schematic of the hybrid electric powertrain system of FIG. 1A, according to an embodiment.

While each of the drawing figures depicts a particular embodiment for purposes of depicting a clear example, other embodiments may omit, add to, reorder, and/or modify any of the elements shown in the drawing figures. For purposes of depicting clear examples, one or more figures may be described with reference to one or more other figures, but using the particular arrangement depicted in the one or more other figures is not required in other embodiments. The drawings and schematic representations are intended to support the understanding of the invention. These may not be to scale and are not intended to limit the invention to any particular layout, connectivity, or architectural implementation. Correspondence between drawing elements and described components is provided for illustrative purposes and should not be interpreted to limit the claim scope.

### DETAILED DESCRIPTION OF THE INVENTION

In the following description, for the purposes of explanation, numerous specific details are set forth in order to provide a thorough understanding of the present disclosure. It will be apparent, however, that the present disclosure may be practiced without these specific details. In other instances, well-known structures and devices are shown in block diagram form in order to avoid unnecessarily obscuring the present disclosure. Modifiers such as “first” and “second” may be used to differentiate elements, but the modifiers do not necessarily indicate any particular order.

With reference to the drawings, the invention will now be described in more detail.

Currently, tracked vehicles are mostly powered by engines and mechanical drivelines. The concept of hybrid tracked vehicles is relatively new and has few references in the industry. Prior art designs include systems that utilize a planetary gear system that drives the tracks, and which is powered by both an electrical system and a mechanical system. The electrical power system may comprise a battery that is connected to a power distribution unit that powers three electric motors that are adapted to drive the planetary gear system.

The present invention provides a solution that explores designs for future tracked vehicles. The present invention has many benefits, including the need for fewer and smaller motors, smaller battery size, and less cooling demand.

The present system combines advantages of both series and parallel hybrid configurations, offering engine versatility that allows the internal combustion engine to operate at any desired speed and torque combination, similar to series hybrid systems, while maintaining the ability to mechanically transmit power directly from the engine to the tracks without electrical conversion losses, similar to parallel hybrid systems. Additionally, the power split design enables a more compact overall system architecture through the use of smaller batteries and motors compared to traditional series or parallel configurations, while also eliminating the need for complex gear-changing transmissions and steering hydraulics that are typically required in conventional tracked vehicle designs. The design incorporates simplified mechanics through the integration of steering functionality directly into the power split system, enhancing overall system efficiency and reducing component count. Furthermore, the system may operate in engine-only mode with a 0V DC bus when electric power is not required, providing operational versatility and allowing the vehicle to continue operating even when electrical systems are offline or when battery power conservation is prioritized.

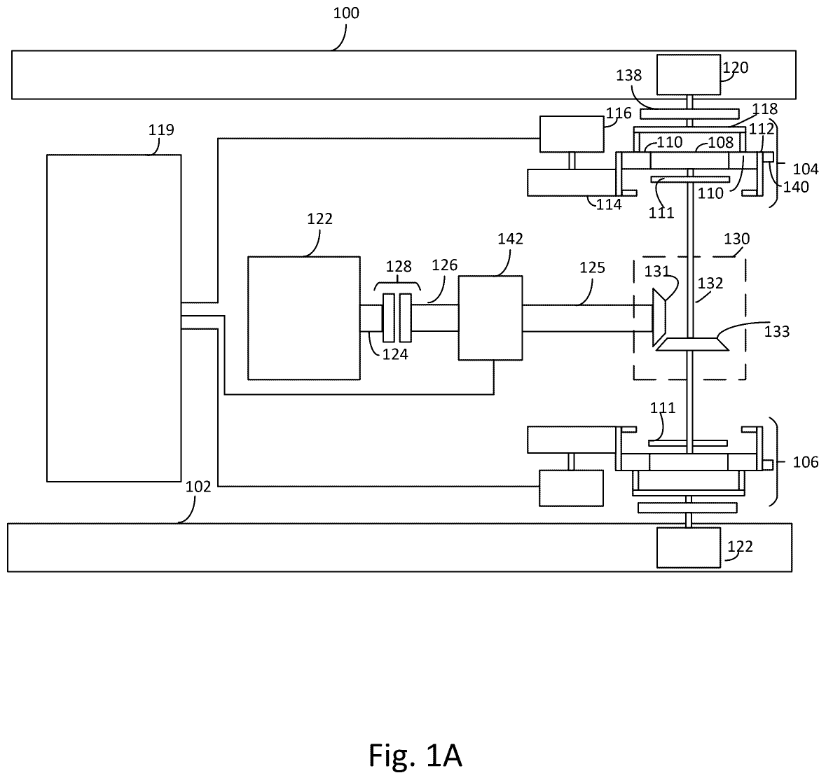

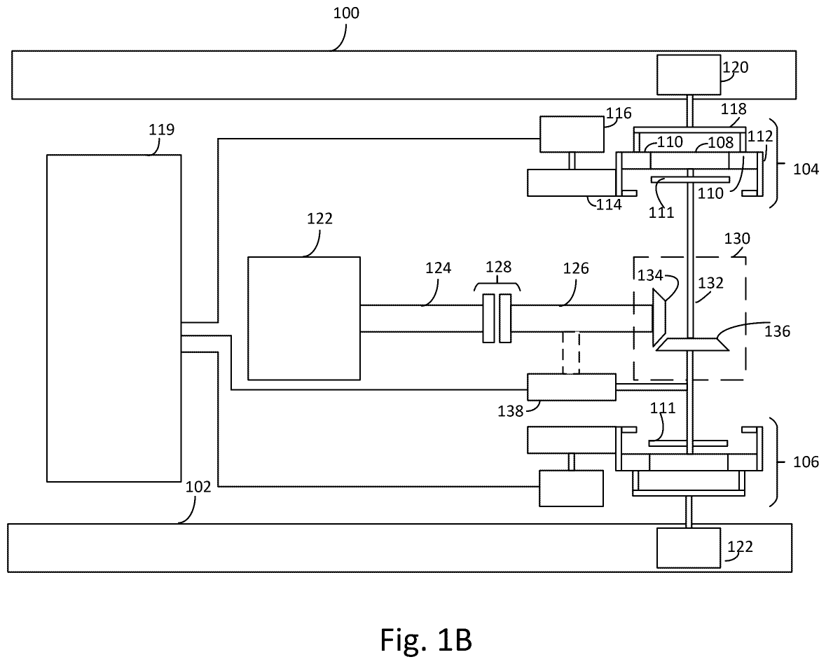

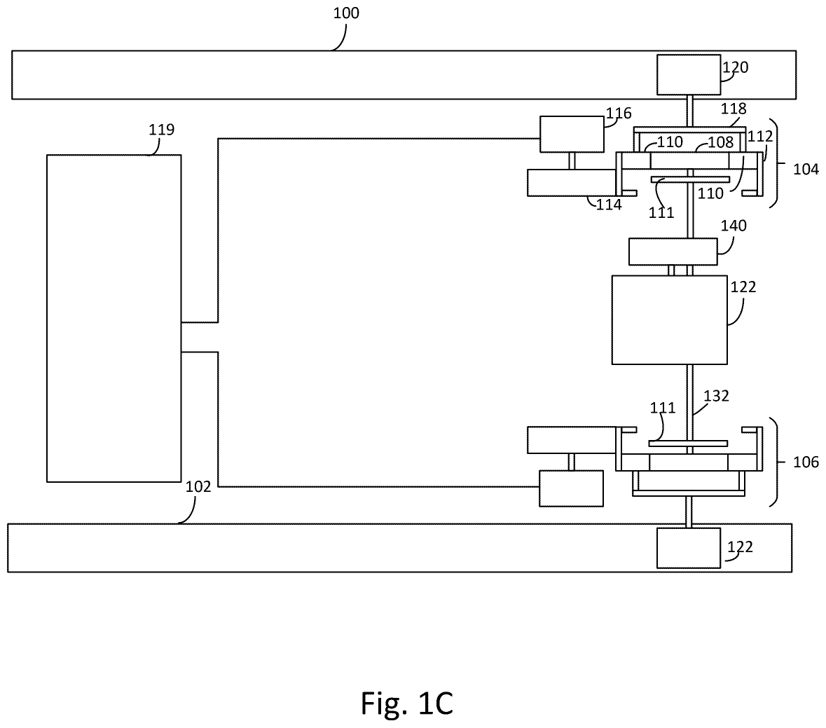

Referring to FIG. 1A, a hybrid electric powertrain system for tracked vehicles is illustrated. The system includes a left track 100 and a right track 102, each driven by corresponding left planetary gear assembly 104 and right planetary gear assembly 106. Each planetary gear assembly includes a sun gear 108, one or more planetary gears 110, and a ring gear 112 that work together to provide power transmission and speed control.

The electric motors 116 are operatively connected to reduction gears 114 that engage with the ring gears 112. In one embodiment, YASA 400 series motors may be employed, providing high power density and efficiency characteristics suitable for tracked vehicle applications. The motors 116 are in electrical communication with a battery 119, which may comprise a high-voltage lithium-ion battery system with capacities ranging from 40-70 kWh and capable of 4C discharge rates (up to 200 kW peak power). When motor 116 is engaged, rotational force is applied through the reduction gear 114 to the ring gear 112, causing the planetary gears 110 to rotate around the sun gear 108, which in turn rotates the carrier shaft 118. The carrier shaft 118 connects to drive sprocket 120, propelling the tracks forward or backward depending on the direction of motor rotation.

The planetary gear assemblies may incorporate specific gear ratios optimized for tracked vehicle performance. The sun gear 108 to planetary gear 110 ratio may range from 3:1 to 10:1, while the ring gear to planetary gear differential can be configured to achieve gear ratios between 1.45:1 and 4:1. These ratios enable the system to provide appropriate torque multiplication and speed reduction for various operating conditions, from high-torque low-speed maneuvering to efficient highway cruising.

The system includes an internal combustion engine 122, which may be a 3.0 L V6 diesel engine such as the FCA 3.0 L Turbo Ecodiesel, Duramax 3.0 L, or Powerstroke 3.0 L, with power outputs ranging from 186-207 kW. The engine connects through a first output gear shaft 124 to a second output gear shaft 126 via a reverse gear 128. The second gear shaft interfaces with a gearbox 130 that engages an axle 132 through a drive pinion 134 and axle ring gear 136 arrangement. When the engine 122 is engaged, rotational power transfers through this gear train to rotate the axle 132, which is operatively connected to the sun gears 108 of both planetary gear assemblies.

The power split hybrid configuration enables multiple operating modes through coordinated control of the engine, electric motors, and brake systems. In hybrid mode, both the engine-driven sun gear and motor-driven ring gear contribute power to the carrier shaft 118, providing enhanced torque and power delivery. The system can operate in engine-only mode by locking the ring gear in a stationary position, allowing the sun gear to drive the planetary gears around the fixed ring gear. Conversely, electric-only mode is achieved by engaging brake assemblies to prevent axle 132 rotation, locking the sun gear while the ring gear drives the planetary gears.

Regenerative energy recovery may be performed at the ring-mounted traction motors 116 and/or at the central motor 142. For a given vehicle speed such as with a fixed carrier speed of 118, the control system selects ring and sun angular speeds (consistent with planetary kinematics) to apportion power between the ring path shown with traction motors 116 driving/absorbing through the ring gears 112 and the sun path shown with engine 122 and/or central motor 142 on the axle 132. To recover energy from the tracks, the controller commands negative torque at one or both traction motors while coordinating engine/central-motor torque so the desired carrier speed is maintained. To recover energy on the input side, the controller may allocate positive engine torque and negative central-motor torque so that the central motor 142 operates as a generator on the sun/axle path. The controller continuously chooses the combination-traction-motor regen, central-motor regen, or both that optimizes efficiency, performance, emissions, thermal limits, and battery 119 state of charge; mechanical brakes 138 and 140 are not required for normal regenerative operation, though they may be used for service or to hold components for optional stationary charging.

Advanced configurations may include multiple planetary gear assemblies in series, where the carrier shaft of a first planetary gear assembly drives the sun gear of a second planetary gear assembly. This arrangement enables compound gear reduction and enhanced torque multiplication. The gear ratios between successive planetary assemblies can be independently optimized, with the first assembly providing initial speed reduction and the second assembly fine-tuning the final output characteristics. Such configurations maximize torque transmission efficiency and allow precise control of the power delivery to each track sprocket.

The brake and clutch control system enables seamless transitions between operating modes. The reverse gear 128 incorporates a clutch mechanism that can disengage the first output gear shaft 124 from the second output gear shaft 126. When the clutch is placed in an open position, brake assemblies automatically engage to prevent axle 132 rotation, effectively locking the sun gears 108 for electric-only operation. The brake system is designed to generate minimal heat since it arrests stationary components rather than slowing rotating masses. Multiple brake configurations are available, including internal brake assembly 111, outside brake assembly 138, and ring brake assembly 140, providing redundancy and precise control over power transmission paths.

The system may incorporate a central motor 142 that provides additional power input to the sun gear through shaft 132 or 126. This central motor enables enhanced torque delivery to the sun gear without requiring engine operation, providing greater flexibility in power management. The independent control of left track 100 and right track 102 through separate electric motors 116 enables precise steering control, as differential speeds between tracks can be achieved by varying the motor speeds without requiring dedicated steering motors or complex transmission systems.

In hybrid mode, the control system determines optimal torque distribution between the engine and electric motors based on operating conditions, battery state of charge, and performance requirements. The motors can modulate ring gear rotational speed to achieve desired sprocket speeds and torque outputs, effectively providing continuously variable transmission functionality. By applying differential rotation to the left and right tracks, the vehicle can execute turns without requiring separate steering motors, as one track operates faster than the other. The power management system can dynamically allocate power between propulsion and battery charging, with the ring gear speed control enabling efficient energy distribution throughout the drivetrain.

Engine-only mode operation can be achieved by engaging brake assembly 111 to prevent ring gear movement, though this configuration limits the system's ability to provide variable gear ratios and may reduce acceleration performance. This mode may be utilized for specific operating conditions where electric power conservation is prioritized over performance optimization.

The transverse engine arrangement may include a modified power transmission path where the engine 122 connects through a reduction gear assembly 140 to transfer rotational power to the axle 132. This configuration may allow the engine to operate at optimal speeds while providing appropriate gear reduction to match the torque and speed requirements of the planetary gear assemblies 104, 106.

When the system provides for straight travel, the carrier angular speed obeys:

$${ω}_{c} = \frac{{N}_{s}}{{N}_{s} + {N}_{r}} {ω}_{s} + \frac{{N}_{r}}{{N}_{s} + {N}_{r}} {ω}_{r}$$

where ω is rotational speed and N is the number of teeth on the gear with s representing the sun gear, r representing the ring gear and c representing the carrier. In one configuration with the engine to track ratio of 8.8, peak track torque can be in the range or 5000 Nm to 5500 Nm which is sufficient to break stickage and friction and can provide a top speed over 50 mph. Further, the power split design allows for a lower traction motor speed by increasing the sun speed. In this case, both motors are now in the continuous bound and there is no need to derate any motors and maintain the power output. “Continuous bound” refers to the continuous power rating of the electric motors, the power level they can sustain indefinitely without overheating or requiring derating. When motors operate above their continuous power rating, they must be derated (power output reduced) to prevent overheating and damage. Further this design allows for increase engine torque output to put the traction motor back into the burst mode (since the motor can survive with higher temperature with RPM<base speed).

With a given vehicle operating speed, the system can adjust the transmission ratios and allow traction motors to operate below the base speed. This allows for longer burst mode operations with over 80% increase in torque and power output.

FIG. 1B illustrates an embodiment of the hybrid electric powertrain system where the internal combustion engine 122 connects through a first output gear shaft 124 to a third output gear shaft 126 via reverse gear 128, which interfaces with gearbox 130 to drive axle 132 through drive pinion 134 and axle ring gear 136. In this configuration, the electric motor 116 connects through reduction gear 114 to ring gear 112 of the planetary gear assembly, while the axle 132 drives the sun gear 108, allowing power from both sources to be combined through the planetary gears 110 and transmitted via carrier shaft 118 to drive sprocket 120. The brake assembly 111 may be engaged to prevent axle rotation when electric-only operation is desired, effectively locking the sun gear 108 and allowing the electric motor 116 to drive the tracks through the ring gear 112, while the auxiliary motor 142 provides additional power input capability to enhance system performance across various operating conditions.

FIG. 1C illustrates a transverse engine configuration where the internal combustion engine 122 is positioned perpendicular to the vehicle's longitudinal axis. This arrangement provides packaging advantages and more efficient use of chassis space while maintaining the power split functionality. The transverse engine connects through a reduction gear assembly 140 to transfer power to the axle 132, allowing the engine to operate at optimal speeds while providing appropriate gear reduction to match the torque and speed requirements of the planetary gear assemblies 104, 106. The brake assembly 111 controls axle 132 rotation, enabling electric-only mode operation when engaged. This configuration offers benefits in vehicle balance, weight distribution, and maintenance accessibility while preserving the hybrid powertrain's operational flexibility.

The battery management system incorporates advanced thermal management and control algorithms to optimize performance across varying environmental conditions. The battery 119 includes temperature sensors and cooling circuits integrated with the vehicle's cooling system to maintain optimal operating temperatures. Sophisticated charge and discharge control algorithms monitor individual cell voltages and temperatures, ensuring balanced operation across all battery cells while maximizing battery life. The system provides multiple power delivery modes, including high-power burst capabilities for demanding operations such as acceleration or steep grade climbing, and sustained power delivery for extended operations. Regenerative charging capabilities work in coordination with electric motors 116 when operating as generators during braking or deceleration, extending operational range and reducing energy consumption. External charging provisions enable extended mission capabilities when the vehicle is stationary, with safety systems preventing overcharging or thermal runaway conditions.

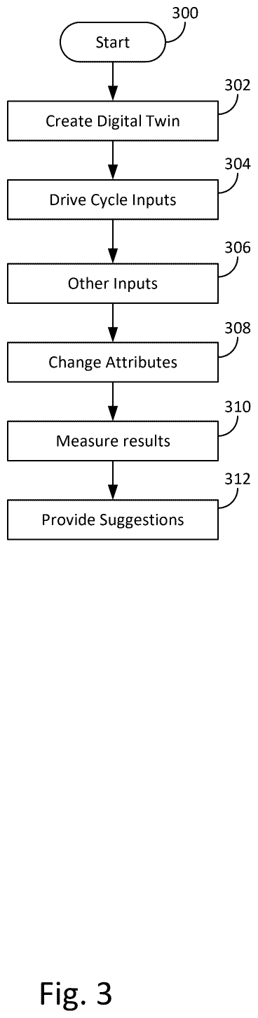

FIG. 3 illustrates a reinforcement learning (RL) based control development methodology for optimizing hybrid powertrain performance. The process begins with creating a digital twin 302 representing the hybrid system components, incorporating attributes from physical prototypes and performance measurements. Drive cycle information and driver inputs are fed into the digital twin at 304, while vehicle sensor data provides real-time system status at 306. The RL-based controller employs artificial intelligence algorithms that automatically adjust component attributes at 308, measure resulting performance at 310, and provide optimization suggestions at 312. The reward function for the control system is defined as R=[m_{fuel}+w*constraints], where constraints include battery limitations and engine switching timing. Sensor inputs include grade, desired acceleration, battery state of charge, velocity, engine status, power demands from ancillary and cooling systems, coolant temperature, and DC bus current.

In one embodiment, the electric motor can assist the driving system with the attributes shown in the following table.

TABLE 1

| Electric Motor assist | A first embodiment | | A second embodiment | |
|---|---|---|---|---|
| Frictional Torque (T_{fric} at | 15 | Nm | 25 | Nm |
| 3100 (N) RPM is | | | | |
| Load Inertia (J) | 0.2 | kg/m² | 0.2 | kg/m² |

| | | |
|---|---|---|
| Gearbox efficiency η_{GB} | 0.95 | 0.95 |
| Motor Efficiency η_{Motor} | 0.6 | 0.9 |

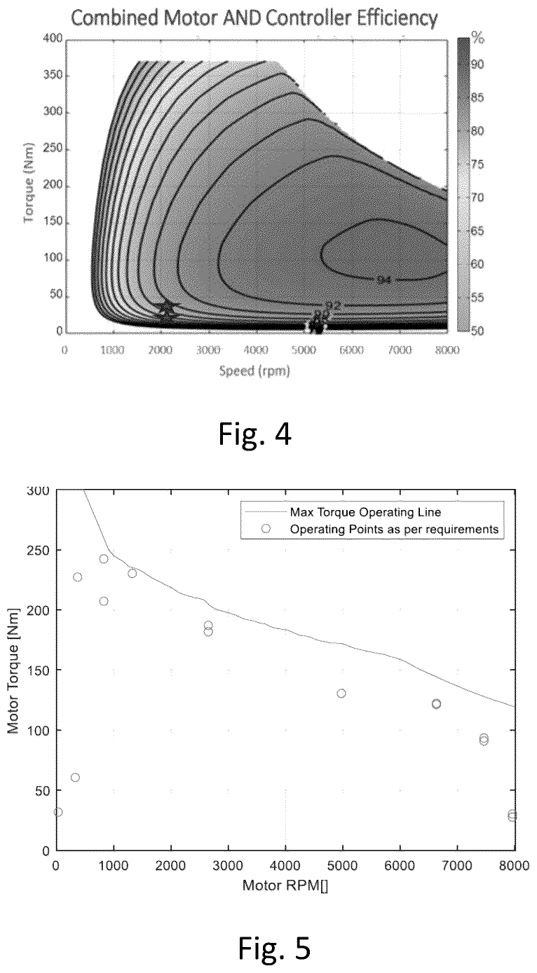

The relationship between the motor and the controller efficiency can be illustrated at FIG. 4.

The power output from the above embodiments can be shown as follows in

TABLE 2
Table 2

| | One embodiment | Second embodiment |
|---|---|---|
| $Power to overcome friction = {T}_{fric} * \frac{2 π N}{90}$ | $15 * \frac{2 π 3100}{60} = 4.87 kW$ | $25 * \frac{2 π 3100}{60} = 8.12 kW$ |
| $Power to overcome inertia = \frac{1}{2} J {ω}^{2}$ | $\frac{1}{2} 0.2 {( \frac{2 π 3100}{60} )}^{2} = 10.5 \; 39 kW$ | $\frac{1}{2} 0. 2 {( \frac{2 π 3100}{60} )}^{2} = 10.5 \; 39 kW$ |
| Total power from motor = | 15.409/.95 = 16.22 KW | 18.659/0.95 = 19.64 KW |
| (P_{fric} + Pᵢₙₑᵣₜᵢₐ)/η_{GB} | | |
| Total power from battery = | 16.22/0.6 = 26 KW | 19.64/0.9 = 22 KW |
| P_{batt}/η_{Motor} | | |

Note that these are for a 0 Torque and 3100 RPM output requirement.

In one embodiment, the relationship between the motor torque and the revolutions per minute (RPM) is shown in FIG. 5. The gear ratio can be show as follows:

$$Gear Ratio = \frac{{ω}_{input shaft}}{{ω}_{outpu t shaft}} = \frac{{τ}_{ouput shaft}}{{t}_{input shaft}}$$

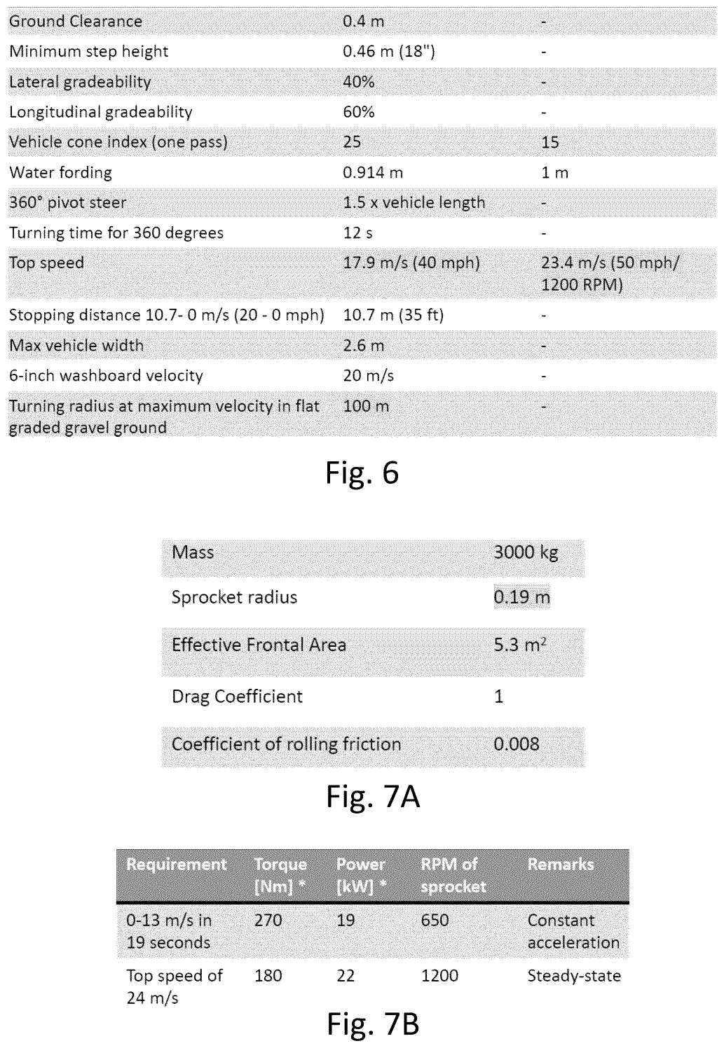

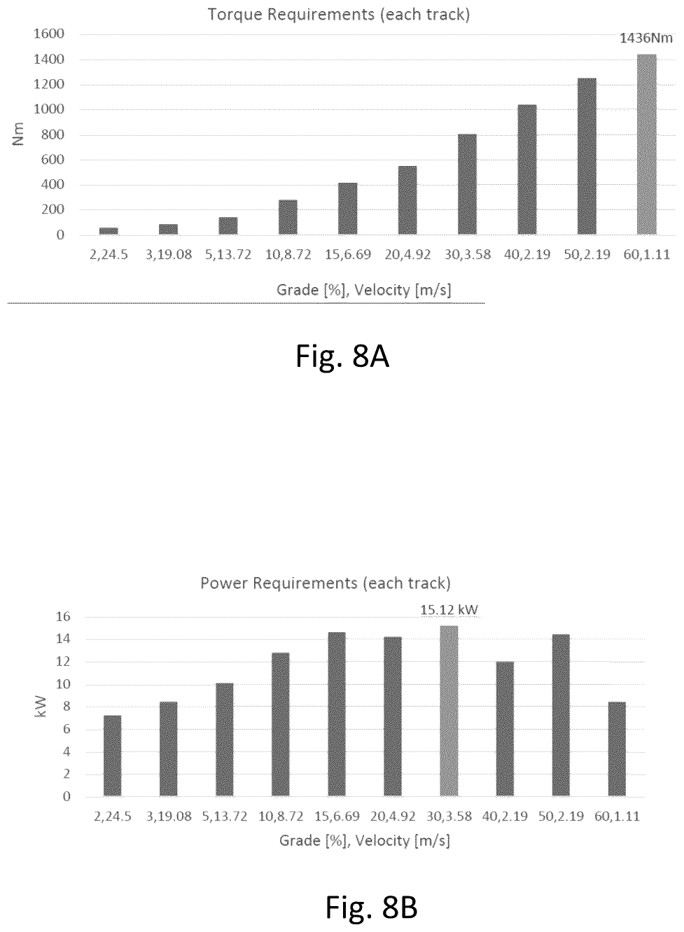

In one embodiment the vehicle meets the requirements shown in FIG. 6. The vehicle minimal performance criteria can be shown in FIGS. 7A and 7B. The power requirements for each track, in one embodiment, can be shows in FIGS. 8A and 8B. These are for power of 8.4 KW, RPM of 55.2854 and Torque of 1436.

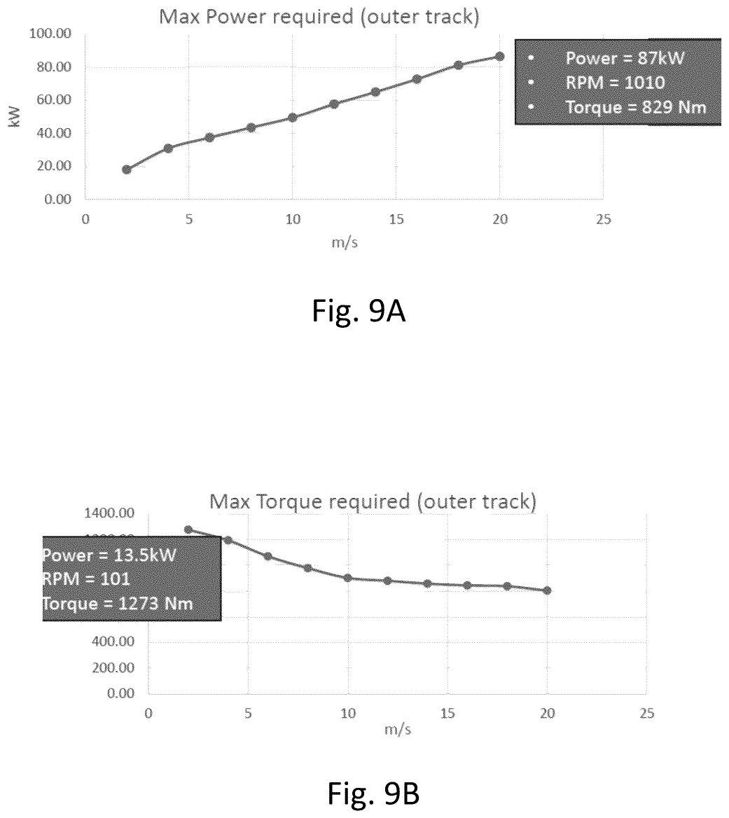

In one embodiment, the power requirement for turning the vehicle is shown in FIGS. 9A and 9B. In one embodiment, the internal combustion engine has the following power requirements as shown in Table 3.

TABLE 3

| | | |
|---|---|---|
| Drive cycle average | 30 | kW |
| Maximum turning power | 85 | kW |
| Auxiliary output (continuous) | 40 | KW |
| Total | 155 | kW |
| Assuming 90% driveline efficiency | 168 | kW |

The engine can be a FCA 3.0 L Turbo Ecodiesel, Duramax 3.0 L, Powerstroke 3.0 L each can be six cylinders with power ranging from 186 Kw to 207 Kw. The minimum internal combustion engine power can be shown by reviewing the continuous auxiliary power and average drive cycle power from Table 4 and 5.

TABLE 4

| | | |
|---|---|---|
| Continuous auxiliary power | 40 | Kw |
| Cooling system power demand | 10 | kW |
| Misc power requirements | 20 | Kw |
| Total demand on the internal combustion | 70 | Kw. |
| engine (assuming 10 kW loss) | | |

TABLE 5

| | Without efficiency | | Including efficiency | |
|---|---|---|---|---|
| Drive Cycle | considerations | | considerations | |
| Highway | 32 | kW | 47 | kW |
| Secondary Drive | 4 | kW | 5.8 | kW |
| Cross Country (at 10 mph) | 6.5 | kW | 9.5 | kW |

The cooling system demand can be derived from the demand from the internal combustion engine which can have a power demand in the range of 3 to 5 KW, the electric motor that can have a power demand of about 2.5 KW and the battery that can have a demand of about 2.5 kW. In one embodiment, the minimum engine power needs to be 117 KW or greater.

In one embodiment, the drive system includes the following attributes as shown in Table 6.

TABLE 6

| Component | Parameter | Values | Units |
|---|---|---|---|
| Electric motor | Estimated power rating | 140 | kW |
| (single speed | Range of gear ratios | 1.45-4 | |
| transmission) | | | |
| Combustion Engine | Minimum power rating | 117 | kW |
| | Maximum power rating | 200 | |
| High Voltage Battery | Minimum energy capacity | 72 | kWh |
| Cooling System | Maximum cooling power | 10 | kW |
| Engine | | | |
| Battery | | | |
| Motors | | | |

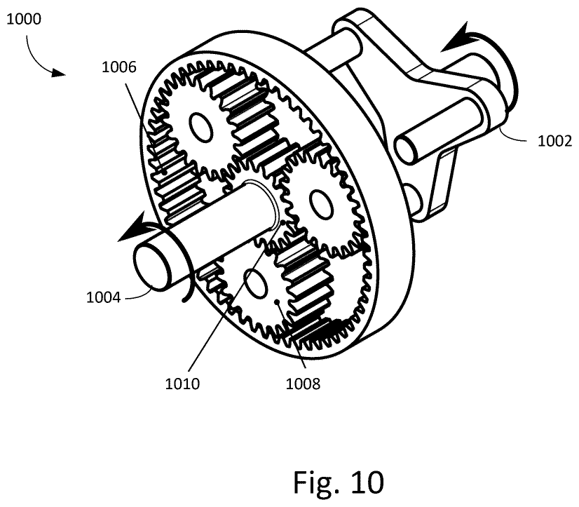

FIG. 10 illustrates the fundamental planetary gear assembly 1000 configuration. The carrier 1002 connects directly or indirectly to the drive sprocket, while shaft 1004 receives input from both the internal combustion engine and electric motor in certain embodiments. Ring gear 1006 connects to an electric motor, enabling variable speed control between the sun gear and ring gear. The ring gear can provide positive torque for propulsion or negative torque for regenerative energy recovery to the battery. Independent left and right planetary gear assemblies with their respective motors enable vehicle steering through differential track speeds, eliminating the need for dedicated steering motors or engines.

The power split design enables steering through differential track speeds without requiring dedicated steering components. Each track operates independently through its planetary gear assembly and motor, allowing precise speed and direction control. Vehicle turning is accomplished by operating the left and right tracks at different speeds, with the power split system managing torque distribution to achieve desired turning characteristics.

Table 7 presents specifications for a representative power split hybrid tracked vehicle implementation. The system features a 3500 kg GVWR vehicle with dimensions of 2993×2540×2850 mm. The engine provides 194 KW/600 Nm with a maximum RPM of 4500, while center and traction motors each deliver 100 KW/300 Nm at up to 8000 RPM. The engine-to-track ratio is 8.8:1, and the track motor-to-track ratio is 6.6:1. The battery pack provides 50 kWh capacity with 4 C discharge capability (200 kW peak power). Under test conditions, this configuration achieved fuel economy improvements of 80-85% over conventional tracked vehicle designs and 15-20% over series and parallel hybrid designs, demonstrating 4.00-5.00 miles per gallon performance.

TABLE 7

| Attribute | Value/Range |
|---|---|
| GVWR | 3500 kg |
| Vehicle dimension (L × W × Hin mm) | 2993 × 2540 × 2850 |
| Engine Power/Torque | 194 kW/600 Nm |
| Engine Max RPM | 4500 RPM |
| Center Motor Power/Torque | 100 kW/300 Nm |
| Center Motor RPM | 8000 RPM |
| Traction Motor Power/Torque | 100 kW/300 Nm |
| Traction Motor RPM | 8000 RPM |
| Engine to Track Ratio | 8.8 |
| Track motor to Track Ratio | 6.6 |
| Battery Pack Capacity/Max C | 50 kWh/4 C (200 kW) |

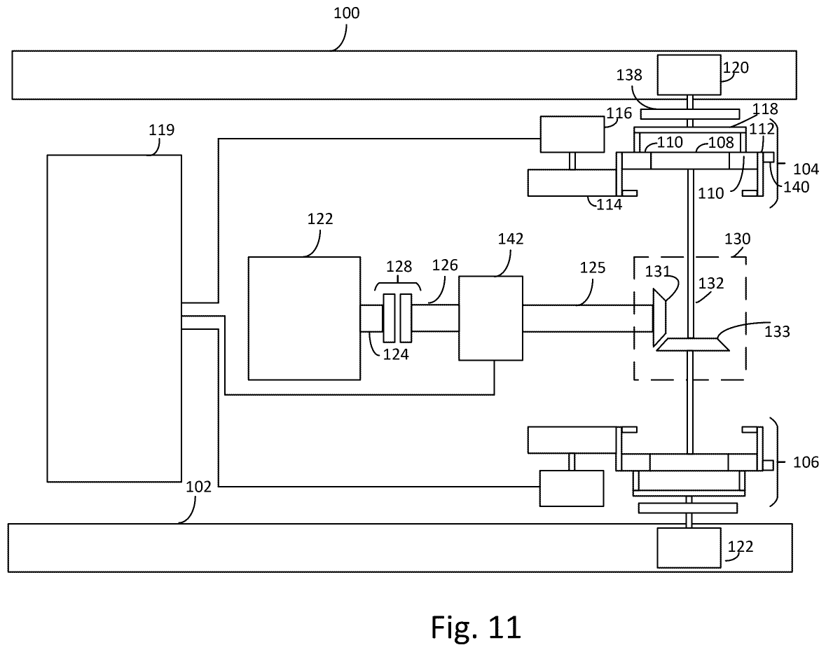

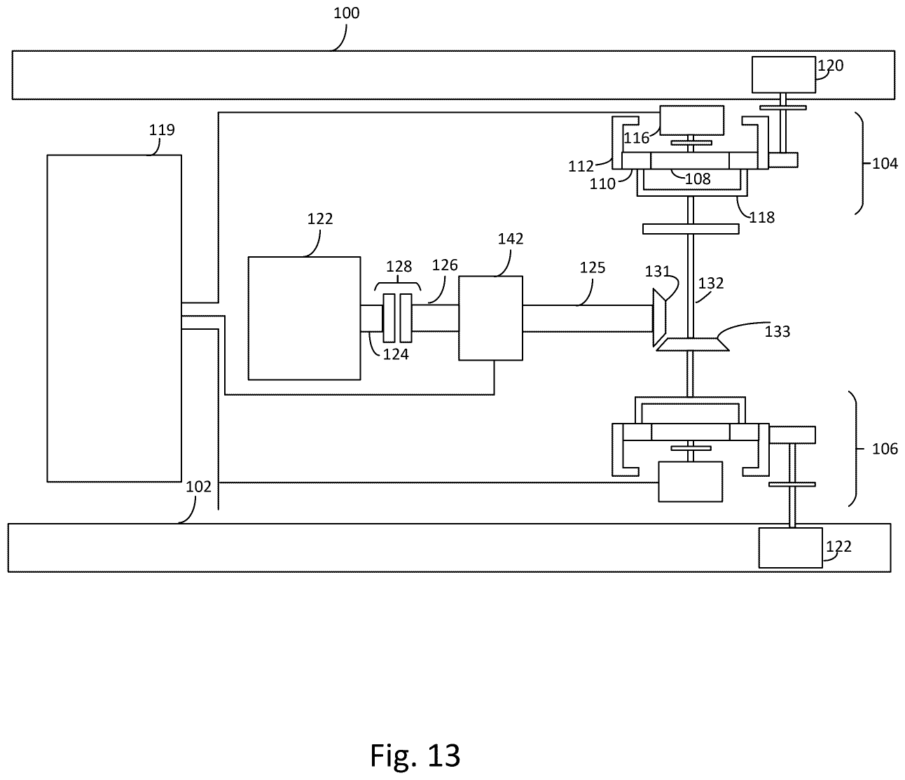

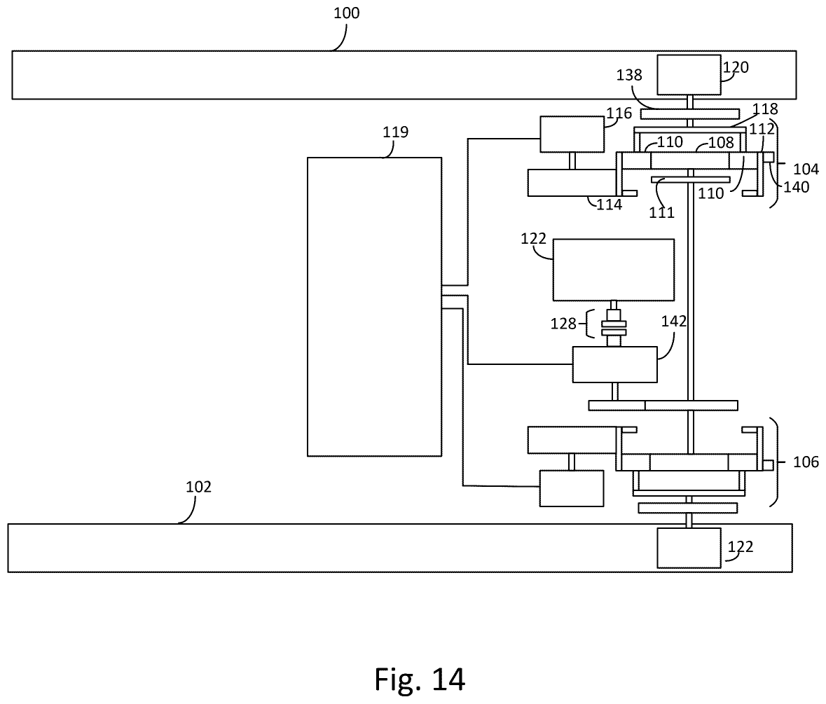

FIGS. 11-14 illustrate various embodiments and configurations of the hybrid electric powertrain system. The core architecture remains consistent across implementations, featuring left and right tracks 100, 102 driven by corresponding planetary gear assemblies 104, 106. Each assembly includes sun gear 108, planetary gears 110, and ring gear 112 for power transmission and speed control. Electric motors 116 connect through reduction gears 114 to the ring gears 112, receiving power from battery 119. Carrier shafts 118 transfer power from the planetary assemblies to drive sprockets 120 or 170 that propel the tracks.

The internal combustion engine 122 provides mechanical power through interconnected shafts, typically including first output gear shaft 124, second output gear shaft 125, and third output gear shaft 126 connected through reverse gear 128. This configuration enables forward and reverse operation while interfacing with gearbox 130, axle housing 131, and axle support 133 that support axle 132 extending through the system to drive the sun gears 108. Various brake assemblies, including brake assembly 111, outside brake assembly 138, ring brake assembly 140, axle brake 1202, and motor brake 1204, provide control over component rotation and enable different operating modes.

Central motor 142 may provide additional power input to supplement the primary engine and traction motors. The brake systems enable selective engagement and disengagement of power transmission paths, allowing the system to operate in engine-only, electric-only, or hybrid modes. When brake assemblies prevent axle 132 rotation, the sun gears 108 are locked, enabling electric-only operation through the ring gears 112. The planetary gear assemblies serve as the power-splitting mechanism, combining and distributing power from multiple sources to the tracks while providing steering capability through differential speed control of the left and right tracks.

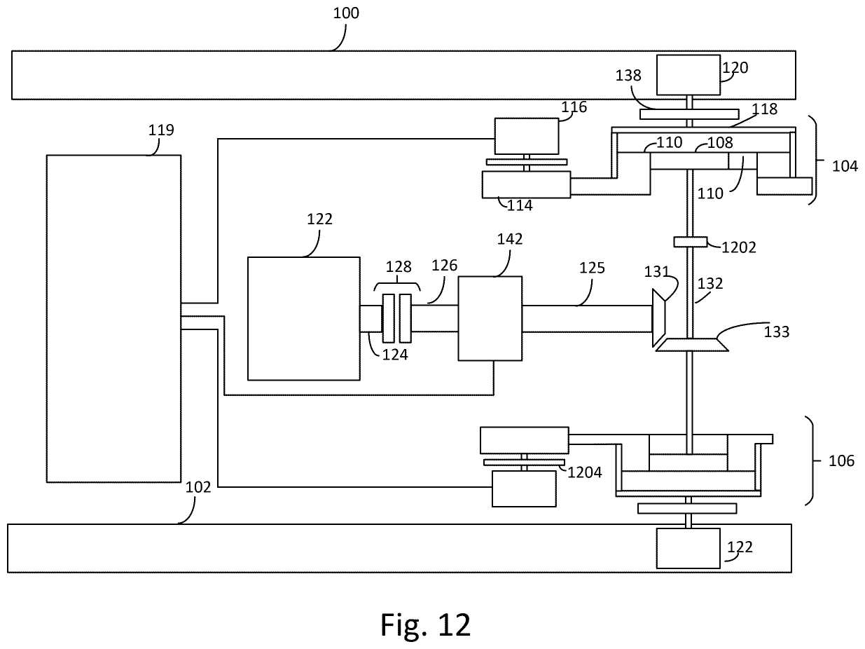

The enhanced brake control systems illustrated in FIG. 12 demonstrate advanced power management capabilities. The axle brake 1202 prevents axle 132 rotation for electric-only mode operation, while the left motor brake 1204 provides fine-tuned control over individual motor operation and power delivery. These brake assemblies work in conjunction with other system components to enable precise control over power distribution and operational modes, allowing seamless transitions between different power sources and operating configurations while maintaining optimal performance characteristics for tracked vehicle applications.

Referring to FIG. 1, the sun brake 111 is optional and can provide for little or low heat friction braking to ensure no rotation at low speeds. The carrier brake 138 can be a disc brake and can provide main vehicle brake. The ring brake 140 can be optional and can also provide for little or low heat friction braking to ensure no rotation at low speeds. The reverse gearbox 128 can be used when full power reverse operation is needed. It can also be used to match engine and center motor RPM with another gear pair. When the gearbox is omitted the system design can preserve high reverse power with the combined power of all the motors and also provides for full torque capacity.

The hybrid electric powertrain system may be represented by a computerized system that creates a digital twin of the tracked vehicle, enabling digital testing and validation of various powertrain configurations. This digital twin may provide a virtual representation of the complete vehicle system, including the power split design, planetary gear assemblies, electric motors, internal combustion engine, and associated control systems.

The digital twin may allow engineers to test and optimize different power split configurations virtually before physical implementation. The system may simulate the performance characteristics of YASA motors used for a dyno design, enabling evaluation of attributes of the system such as torque delivery, efficiency curves, and thermal management across various operating conditions. The digital representation may include brake system modeling, allowing for testing of different brake engagement strategies and their effects on power distribution between engine-only, electric-only, and hybrid operating modes.

In some embodiments, the computerized system may represent a Winters gearbox model within the digital twin, providing accurate simulation of gear ratios and mechanical power transmission characteristics. This virtual testing capability may enable optimization of gear ratios between the motors and tracks, allowing engineers to evaluate different configurations for specific mission requirements or vehicle performance targets.

The digital twin may simulate real-world operating conditions, including various terrain types, grade climbing, turning maneuvers, and acceleration profiles. Virtual testing may allow for evaluation of battery state of charge management, regenerative braking effectiveness, and overall system efficiency under different drive cycles. The system may model the interaction between the power split mechanism and the differential track speed control required for vehicle steering.

The computerized system may provide predictive analysis capabilities, allowing engineers to assess component wear, thermal loading, and system reliability over extended operating periods. Virtual testing may enable rapid iteration of control algorithms, power management strategies, and component sizing without the time and expense associated with physical prototyping. The digital twin may also facilitate training and operator familiarization with the hybrid powertrain system before deployment of physical vehicles.

According to one embodiment, the processes, techniques and functionality described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the processes, techniques and functionality, or may include one or more general purpose hardware processors configured, adapted and programmed to perform the processes, techniques and functionality pursuant to program instructions, such as computer readable instructions, in firmware, memory, other storage, or a combination. Such special-purpose computing devices may also combine custom hard-wired logic, ASICs, or FPGAs with custom programming to accomplish the processes, techniques and functionality. The special-purpose computing devices may be desktop computer systems, portable computer systems, handheld devices, networking devices or any other device that incorporates hard-wired and/or program logic to implement the processes, techniques and functionality.

One or more different inventions may be described in the present application. Further, for one or more of the invention(s) described herein, numerous embodiments may be described in this patent application, and are presented for illustrative purposes only. The embodiments described are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art will recognize that the one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that must be present in all embodiments.

Headings of sections provided in this patent application and the title of this patent application are for convenience only, and are not to be taken as limiting the disclosure in any way.

It is understood that the above descriptions and illustrations are intended to be illustrative and not restrictive. It is to be understood that changes and variations may be made without departing from the spirit or scope of the following claims. Other embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

1. A hybrid electric powertrain for tracked vehicles, comprising:
a first planetary gear assembly driven by a first motor and operatively connected to a first end of an axle wherein the first planetary gear assembly and the first motor combination provide power to a first track;
a second planetary gear assembly driven by a second motor and operatively connected to a second end of the axle wherein the second planetary gear assembly and the second motor combination provide power to a second track;
a third motor connected to an output gear shaft and operatively connected to the axle;
an internal combustion engine mechanically coupled to the axle via a gear train; and an optional central motor mechanically coupled to the axle;
a battery that is in electrical communication with the first, second and third motor; and
a brake assembly configured to selectively prevent rotation of the axle to hold a sun gear included in the first planetary gear assembly for an electric-only operation, and optionally to prevent rotation of a ring gear included in the first planetary gear assembly for an engine-only operation.

2. The hybrid electric powertrain for tracked vehicles of claim 1 wherein the second planetary gear assembly is carried by a first carrier shaft of the first planetary gear assembly such that when the first carrier shaft is rotated, a second sun gear is also rotated.

3. The hybrid electric powertrain for tracked vehicles of claim 1, wherein the first motor is operatively connected to a reduction gear that engages with a ring gear of the first planetary gear assembly.

4. The hybrid electric powertrain for tracked vehicles of claim 1, wherein a first ring gear of the first planetary gear assembly has an unlocked position where a first sun gear of the first planetary gear assembly may rotate freely and a locked position where the first sun gear may not rotate, and wherein the first ring gear is placed in a locked position when the first sun gear is rotated by the axle.

5. The hybrid electric powertrain for tracked vehicles of claim 4, wherein a first carrier shaft of the first planetary gear assembly has an unlocked position where the first carrier shaft may rotate freely and a locked position where the first carrier shaft may not rotate, and wherein when the first carrier shaft is placed in the locked position, rotation of the first sun gear causes the first ring gear to rotate thus rotating the first motor and recharging the battery.

6. The hybrid electric powertrain for tracked vehicles of claim 1, wherein the first motor, second motor, and third motor may be independently controlled to provide differential power distribution, allowing the first track and second track to operate at different speeds for vehicle steering.

7. The hybrid electric powertrain for tracked vehicles of claim 1, wherein the system may operate in an engine-only mode by engaging the engine to apply power to the axle.

8. A hybrid electric powertrain system for tracked vehicles, comprising:
a left track and a right track;
a left planetary gear assembly and a right planetary gear assembly, each planetary gear assembly including a sun gear and planetary gears;
electric motors operatively connected to reduction gears, which engage with the planetary gear assemblies;
a battery providing electrical power to the electric motors;
carrier shafts extending from each planetary gear assembly and connecting to drive sprockets that engage with and drive the left track and right track;
an internal combustion engine providing mechanical power through a first output gear shaft that connects to a second output gear shaft, which connects to a third output gear shaft through a reverse gear;
an axle housing supporting an axle, which is further supported by an axle support;
a central motor positioned to provide additional power input to the system;
an outside brake assembly providing control over component rotation; and,
an axle brake that may be engaged to prevent rotation of the axle.

9. The hybrid electric powertrain system of claim 8, wherein each planetary gear assembly further includes a ring gear, and wherein the electric motors are operatively connected to the ring gears through the reduction gears.

10. The hybrid electric powertrain system of claim 8, wherein the axle is operatively connected to the sun gears of both the left planetary gear assembly and the right planetary gear assembly such that rotation of the axle rotates the sun gears.

11. The hybrid electric powertrain system of claim 8, wherein when the axle brake is engaged to prevent rotation of the axle, the electric motors provide power solely through the ring gears to drive the left track and right track.

12. The hybrid electric powertrain system of claim 8, wherein the central motor is operatively connected to provide additional power input through the third output gear shaft.

13. The hybrid electric powertrain system of claim 8, wherein the reverse gear allows for forward and reverse operation of mechanical power transmission from the internal combustion engine.

14. The hybrid electric powertrain system of claim 8, wherein the system is configured to operate in multiple modes including an engine-only mode, an electric-only mode, and a hybrid mode where both the internal combustion engine and electric motors provide power simultaneously.

15. A hybrid electric powertrain system for tracked vehicles, comprising:
a left track and a right track driven by corresponding left planetary gear assembly and right planetary gear assembly, each planetary gear assembly including a sun gear, planetary gears, and a ring gear;
electric motors operatively connected to reduction gears, which engage with the ring gears of the planetary gear assemblies;
a battery providing electrical power to the electric motors;
carrier shafts extending from each planetary gear assembly and connecting to drive sprockets that engage with and drive the left track and right track;
an internal combustion engine providing mechanical power through the system configuration;
a reverse gear allowing for forward and reverse operation of the mechanical power transmission;
an outside brake assembly and a ring brake assembly providing enhanced control capabilities for component rotation; and
a central motor positioned to provide additional power input to the system through a gear interface connection.

16. The hybrid electric powertrain system of claim 15, wherein the brake assembly is configured to prevent rotation of specific components to enable the electric motors to provide power solely through the reduction gears and planetary gear assemblies to drive the left track and right track.

17. The hybrid electric powertrain system of claim 16, wherein when the brake assembly is engaged, the system operates in an electric-only mode where power is provided exclusively by the electric motors through the ring gears.

18. The hybrid electric powertrain system of claim 15, wherein the planetary gear assemblies are power-splitting assembly adapted to allow power from both the internal combustion engine and electric motors to be combined and distributed to the left track and right track.

19. The hybrid electric powertrain system of claim 18, wherein the carrier shafts output the combined power from the planetary gear assemblies to the drive sprockets, which transfer rotational force to move the left track and right track.

20. The hybrid electric powertrain system of claim 15, wherein the system is configured to provide steering capability through differential speed control of the left track and right track by independently controlling the electric motors and brakes.
